(19) United States
(12) Patent Application Publication
(10) Pub. No.: US 2011/0260963 A1
(43) Pub. Date: Oct. 27, 2011

(54) SYMBOLIC INPUT VIA MID-AIR FINGER/THUMB MOTIONS

(75) Inventor: Adam T. Timmons, Southfield, MI (US)

(73) Assignee: GM GLOBAL TECHNOLOGY OPERATIONS, INC., Detroit, MI (US)

(21) Appl. No.: 12/767,867

(22) Filed: Apr. 27, 2010

(51) Int. Cl. G09G 5/00

(52) U.S. Cl. 345/156

(57) ABSTRACT

An information system includes primary inductance coils driven by an energy source, secondary inductance coils, a processor, a display device, and a lookup table. The processor determines an inductance value generated when coils are brought into proximal interaction with each other. The processor extracts associates alphanumeric or other symbolic information from the lookup table, and transmits the symbolic information to the display device. A circuit is also provided that generates the symbolic information for presentation via the display device, and includes an electrically-driven inductance coil positionable on a thumb of a user, passively-driven inductance coils positionable on the various phalanges of the user's fingers, the processor, and the lookup table. A method for generating and recording symbolic information includes determining the inductance value, associating the inductance value with corresponding symbolic information in the lookup table, and transmitting the symbolic information to a display device.

### TECHNICAL FIELD

The present invention relates to the automated generation and recording of alphanumeric or other symbolic information.

### BACKGROUND OF THE INVENTION

The processing capabilities of modern cell phones and other portable electronic devices have evolved to the point that these devices are, in essence, body-worn personal computers allowing a wearer to simultaneously view both real and virtual information. In order to interact with the virtual domain, a physical input device such as a keyboard, mouse, or a remote wand is typically required. However, such devices may not allow a user to simultaneously see and interact with both the real and the virtual domains, particularly in the context of entry of alphanumeric and other symbolic data.

### SUMMARY OF THE INVENTION

Accordingly, a system is provided herein that eliminates the need for the data input devices noted above. Instead, alphanumeric or other symbolic input is provided by motions of a user's hands, and by the detection and processing of resultant inductance signals and/or changes therein. For example, miniature loops or coils of wire, either of simple or complex shape and/or number, are clandestinely mounted at key locations on the user's person. For example, the coils may be positioned at the tips and various phalanges of the user's fingers and thumbs, at other locations on or adjacent to the user's torso and/or legs, or, in another embodiment, on surfaces that are remote from the user's person. A microelectronic circuit continuously drives and monitors the inductance of electrically-driven coils during proximal interactions with passive coils, such as a light contact or sufficiently close proximity between the driven and passive coils. The proximal interaction results in unique changes in inductance values, which are automatically associated with predetermined symbolic information, which is stored in one or more lookup tables. The symbolic information may then be presented to the user for instant visual, audio, and/or tactile-based feedback.

In particular, the system includes one or more driven or primary inductance coils in direct electrical connection with an energy source, passive or secondary inductance coils each mounted at different predetermined locations, e.g., on the user's person or separate from the user depending on the embodiment, a processor, a display device, and a lookup table. The processor determines an inductance value generated when the primary inductance coil is brought into proximal interaction with one of the secondary inductance coils, and the lookup table associates the inductance value with predetermined symbolic information. The processor automatically extracts the symbolic information from the lookup table in response to the proximal interaction of the driven and passive coils, and then transmits the symbolic information to the display device for audio, visual, and/or tactile presentation of the symbolic information.

A microelectronic circuit is adapted for generating symbolic information for presentation via a display device includes an electrically-driven inductance coil, a plurality of passively-driven inductance coils, the processor, and the lookup table. The processor is configured for transmitting the corresponding symbolic values to the display device for audio, visual, and/or tactile-based presentation of the symbolic information.

A method for generating and recording symbolic information includes providing a driven or primary inductance coil that is electrically connected to an energy source, and providing a plurality of passive or secondary inductance coils. Each of the primary and secondary inductance coils are mounted at different predetermined locations, e.g., points on the user or points on surfaces external to the user. The method includes using a processor to determine an inductance value generated when the primary inductance coil is brought into proximal interaction with the secondary inductance coil, then associating the inductance value with corresponding symbolic information in a lookup table. The associated symbolic information is ultimately transmitted to and presented via a display device in an audio, visual, and/or tactile form.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a system for detecting inductance values and for translating these values into associated alphanumeric or other desired symbolic information;

FIG. 2 is a schematic illustration of a user's hand engaging a mating pair of inductance coils to thereby generate an inductance value for use within the system of FIG. 1;

FIG. 3 is a schematic illustration of alternative coil locations; and

FIG. 4 is a flow chart describing a method for generating symbolic information using the system shown in FIG. 1.

### DESCRIPTION OF THE PREFERRED EMBODIMENTS

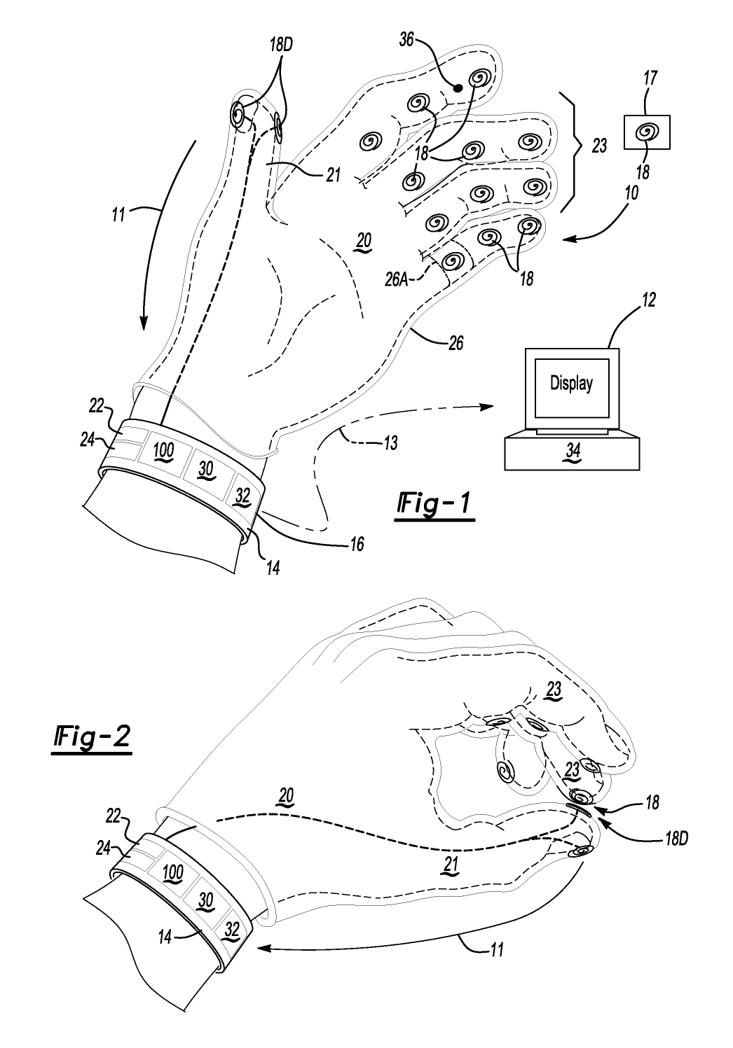

Referring to the drawings wherein like reference numbers correspond to like or similar components throughout the several figures, a system 10 is shown in FIG. 1. System 10 is adapted for generating and detecting inductance values, represented as inductance signals 11, translating the inductance signals into associated symbolic information 13, e.g., alphanumeric information, images, etc., and presenting the associated symbolic information in at least one of an audio, visual, and touch or tactile-based form via a display device 12.

The system 10 may include a user-wearable band 14, e.g., a bracelet or watch as shown, or alternatively a belt, badge, lapel pin, or other device. Band 14 is in proximity to an electrically-driven coil 18D as explained below, and includes a microcomputer device 16. Microcomputer device 16 ultimately transforms the inductance signals 11 into associated symbolic information 13 using an algorithm 100 as described below with reference to FIG. 4. The symbolic information 13 is then transmitted by the microcomputer device 16 to the display device 12 for audio, visual, and/or tactile presentation.

Central to the intended operation of system 10 is the principal of electrical inductance, i.e., the behavior of a coil of wire in resisting a change in electrical current, or Δi. The inductance (L) maybe stated as:

$$L = \frac{N Φ}{i} ,$$

where N=the number of turns in the coil of wire, Φ is the magnetic flux through the area enclosed by a wire loop or coil 18, and i is the electric current in the coil.

To that end, a plurality of miniature inductance coils 18 are positioned at various locations or integrated into various surfaces. As used herein, the term coil refers to one or more loops of wire, whether of a simple or a complex shape. In one embodiment, the coils 18 are positioned on the thumb 21 and fingers 23 of a user's hand 20, one of which is illustrated in FIG. 1. The coils 18 are configured as passively-driven or secondary loops of wire, with the exception of one or more electrically-driven or primary coils 18D. A primary coil 18D may be positioned at any suitable location, e.g., on hand 20, such as on both sides of a thumb tip as shown.

Each primary coil 18D is energized by an energy supply 22, e.g., of the band 14. Energy supply 22 may be a rechargeable battery or other suitable energy storage device capable of energizing the coil(s) 18D. The energy supply 22 may be electrically connected to a voltage inverter 24 suitable for providing an alternating current (AC) output to each primary coil 18D. A light contact or other proximal interaction between any secondary coil 18 and a primary coil 18D as set forth below generates a change in the inductance signal 11, which is processed by microcomputer device 16 in order to determine the associated symbolic information 13.

In different embodiments, the coils 18, 18D shown in FIG. 1 may be connected to an optional glove 26, to individual finger bands 26A, or subdermally-embedded in the hand 20, with the various coils positioned at accessible locations on or along the various phalanges of the hand. In the particular embodiment shown in FIG. 1, a primary coil 18D may be positioned on the front and back of each thumb tip, and secondary coils 18 may be positioned on at least three locations on the front of each finger 23, e.g., at a tip, between the base and mid-knuckles, and between the upper and mid knuckles, although other locations may also be envisioned as discussed below. While a user-worn set of coils 18, 18D are shown in FIG. 1, those of ordinary skill in the art will recognize other possible embodiment in which some of the coils may be embedded within or positioned on or with respect to various surfaces 17 external to the user, e.g., surfaces of a steering wheel, table, doorbell, etc. For example, surfaces 17 may include a coffee mug with coil(s) 18, and a warming/cooling cup holder with coil(s) 18D. When the mug goes into the holder, the holder can recognize, via the resultant inductance signals 11, a temperature at which the user would like the mug maintained.

Still referring to FIG. 1, the microcomputer device 16 includes a central processing unit 30 configured to rapidly process the inductance signals 11. As understood by those of ordinary skill in the art, induction signal intensity decreases roughly as the inverse of the square distance between coils, and therefore coil proximity is required to properly register an input. Energy supply 22 therefore provides a minimal required amount of electricity, as well as information connectivity, e.g., Bluetooth® or similar technology, suitable for linking to the display device 12 and the microcomputer device 16.

Microcomputer device 16 may be loaded or programmed with one or more lookup tables 32 that may be automatically accessed by the microcomputer device. Information extraction from any lookup table 32 can be used for translating the inductance signals 11 into corresponding symbolic information 13 during execution of algorithm 100, described below with reference to FIG. 4. Lookup table(s) 32 may be pre-populated with assignment data correlating to a given inductance value with a given alphanumeric character, string of characters, image, graphic, or other symbolic information.

When certain coils 18, 18D are brought into proximal interaction, i.e., lightly touched together or brought into sufficiently close proximity to each other to thereby register an input, the contact or proximal interaction generates a unique inductance value or a change in inductance value that the microcomputer device 16 compares to the symbolic information stored in the lookup table(s) 32. The corresponding symbolic information can be selected by the microcomputer device 16 from lookup table(s) 32 and transmitted to display device 12. Display device 12 and/or microcomputer device 16 may optionally include, or may be configured to access an application(s) 34. Application 34 may be sight-based-to-hearing-based (e.g., text-to-speech), sight-to-touch-based (e.g., text-to-Braille), hearing-to-sight-based (e.g., speech-to-text), and/or hearing-to-touch (e.g., speech-to-Braille), for presentation enhancement. Application(s) 34 may be selected by a user so that the symbolic information 13 is presentable to a user in a desired format. Application 34 may be of particular use when the information is a string of values or characters such as a number, word, phrase, sentence, or other symbolic input for control or manipulation of on-screen devices such as a mouse pointer.

In the particular embodiment of FIG. 1, with the coils 18, 18D distributed as shown in that figure, the total number of possible inputs is 16 per hand, or 32 total inputs. Possible shorthand includes: thumb tip (TT), index finger tip (IFT), middle finger tip (MFT), ring finger tip (RFT), little finger tip (LFT), index finger middle (IFM), index finger base (IFB), thumb back (TB), thumb front (TF), right hand (RH), left hand (LH), etc. Contact between the right hand thumb tip (TT) and the tip of the right hand index finger (IFT) may be represented as (RH)(TT-IFT). This particular contact may be pre-associated with the letter “A” and recorded in lookup table(s) 32, and so on for the remaining letters and numbers.

Similarly, punctuation, spacing, and mouse pad functionality may be assigned to other coil contact or proximal interaction combinations. In another embodiment, the associated symbolic information may be customizable by the user so that data entry may be kept private, i.e., a person using a similar system 10 in proximity to the user, without foreknowledge of the contents of lookup table(s) 32 in the first user's system, would receive unintelligible data if the symbolic information 13 of the first user were somehow intercepted by the second user.

The associated symbolic information 13 is not limited to letters, numbers, and other keyboard symbols. As the use of a mouse provides other functions, e.g., left and right click, highlighting, selecting of text, etc., a mouse mode may also be provided. By way of example, left and right mouse button functionality may be assigned to a corresponding pair of coils 18, 18D as noted above. In this optional mode, an optical detector 36 may be positioned at the tip of an index finger in order to move a cursor on display device 12 in the two-dimensional display plane while the user's finger moves across a surface.

Referring to FIG. 2, a hand 20 is shown executing a coil contact maneuver, with the resultant inductance signals 11 being generated by the contact. The microcomputer device 16 may be configured to continuously monitor a gain value (G) in a circuit formed by the contacting or proximate coils. The resistance value (R) may be constant, with the inductance value (L) varying depending on which pair of coils is brought into mutual proximity. To optimize variability of the inductance signals 11, the coils themselves may be sized differently, as well as shaped with sufficient variance, e.g., as round, triangular, D-shaped, square, or any other suitable coil shape.

The gain value (G) is a function of the circuit inductance value (L), and may be measured relative to the resistance value (R) using the following formula:

$$G = \frac{R}{\sqrt{{R}^{2} + {( ω L )}^{2}}} ,$$

where ω is the angular frequency of the AC driving voltage delivered to the driving coil 18D, i.e., 2πf, where f is the frequency in Hz. If the secondary coils 18 are constructed sufficiently differently from each other, such as in size and/or shape as noted above, the gain value (G) and the inductance value (L) can change in a meaningful or distinguishable way when the driving coil 18D contacts any of the secondary coils 18.

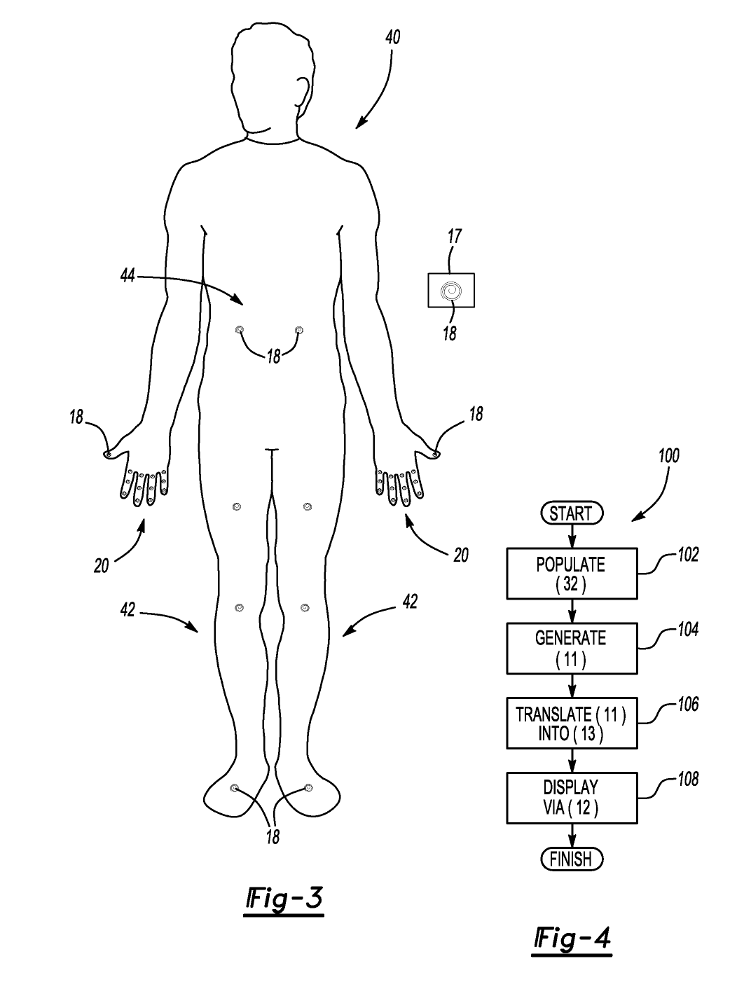

Referring to FIG. 3, although data entry is naturally a manual process, the distribution of coils 18, 18D is not limited to the surfaces of the hands 20. For example, other possible locations on the user's person can be fitted with coils 18, such as the torso 44 and legs 42, with driving coils 18D placed on the thumb 21 as shown in FIG. 1 or any other suitable location. As noted above, coils 18 may be embedded within or positioned on surface 17 external to the user, e.g., a table surface, a steering wheel, a door bell, etc. Indeed, both the number and distribution of coils 18, 18D is essentially unlimited, and may be varied to cover the desired scope of information.

Touch combinations may be assigned not only to the various symbolic characters, but also to entire phrases or character strings. For example, a touch of a finger to a coil positioned on a knee might be translated as “stop off at the grocery store on the way home”, or “pick up kids from school”, a message which may be instantly transmitted to and displayed on and/or spoken via the display device 12, e.g., on a navigation screen in a vehicle, a personal data assistant, a cell phone, etc.

Referring to FIG. 4, algorithm 100 begins with step 102, wherein the symbolic information 13 is associated with corresponding coil contacts or proximal interactions as set forth above, and stored in a lookup table(s) 32. Step 102 may be factory preset in one embodiment, with the associations unchangeable by the user to provide a low cost or a standardized data entry approach. In another embodiment, the factory preset associations may be modified by the user, either in whole or in part, or simply expanded upon without changing any of the presets, for example by adding more coils 18, 18D and associating contacts with the news coils within lookup table(s) 32.

At step 104, the inductance signals 11 are generated by coil contact set explained above, and transmitted to the microcomputer device 16. The signals 11 may be temporarily stored in memory, or suitably processed or buffered by microcomputer device 16. The algorithm 100 then proceeds to step 106.

At step 106, the microcomputer device 16 automatically translates the inductance signals 11 into corresponding symbolic information 13. Step 106 may include comparing the measured or calculated inductance signals 11 from step 104 to associated symbolic information 13 stored in the lookup table(s) 32, and then extracting the associated information from the lookup table(s). The algorithm 100 then proceeds to step 108.

At step 108, the symbolic information 13 is transmitted via a wired or a wireless connection, e.g., using Bluetooth®, to the display device 12. The user may then instantly view, hear, and/or feel the presented information and edit it as needed.

While the best modes for carrying out the invention have been described in detail, those familiar with the art to which this invention relates will recognize various alternative designs and embodiments for practicing the invention within the scope of the appended claims.

1. A system comprising:
a primary inductance coil in direct electrical connection with an energy source;
secondary inductance coils, wherein the primary inductance coil and each of the secondary inductance coils are mountable at different predetermined locations;
a processor adapted for determining an inductance value that is generated when the primary inductance coil is brought into proximal interaction with one of the secondary inductance coils;
a display device in communication with the processor; and
a lookup table associating the inductance value with predetermined symbolic information;
wherein the processor automatically extracts the symbolic information from the lookup table in response to the proximal interaction, and transmits the symbolic information to the display device for presentation of the symbolic information.

2. The system of claim 1, wherein the processor is connected to a band that is wearable by a user of the system.

3. The system of claim 2, wherein the secondary inductance coils are each positioned on the user's fingers, and the primary inductance coil is position on the tip of the user's thumb.

4. The system of claim 2, further comprising one of a glove and a plurality of finger bands wearable by the user, wherein the primary coil and the secondary coils are connected to the glove or the finger bands.

5. The system of claim 1, wherein at least some of the primary and the secondary coils are connected to a point on a user of the system.

6. The system of claim 5, wherein at least some of the primary and the secondary coils are connected to a surface external to the user.

7. The system of claim 1, wherein the symbolic information includes a string of characters.

8. The system of claim 1, further comprising an application configured for presenting the symbolic information as at least one of audible speech, visual text, and tactile feedback.

9. A circuit adapted for generating symbolic information for presentation via a display device, the circuit comprising:
an electrically-driven inductance coil positionable on a point of a user;
a plurality of passively-driven inductance coils positionable on the various phalanges of the user's fingers;
a processor adapted for determining an inductance value when the electrically-driven inductance coil is brought into proximal interaction with one of the passively-driven inductance coils; and
a lookup table associating the inductance value with corresponding symbolic information;
wherein the processor is configured for transmitting the corresponding symbolic information to the display device for at least one of a text-based, a speech-based, and a tactile-based presentation.

10. The circuit of claim 9, wherein the processor is connected to one of:
a bracelet and a watch wearable by the user.

11. The circuit of claim 9, further comprising one of a glove and a plurality of finger bands, wherein the electrically-driven and passively-driven coils are connected to the glove or the finger bands.

12. The circuit of claim 9, wherein the symbolic information includes a string of characters.

13. A method for generating and recording symbolic information, comprising:
providing a primary inductance coil that is electrically connected to an energy source, and a plurality of secondary inductance coils passively drivable by the primary inductance coil, wherein each of the primary and secondary coils is mounted at a different predetermined location;
using a processor to determine an inductance value generated when the primary inductance coil is brought into proximal interaction with the secondary coil;
associating the inductance value with corresponding symbolic information in a lookup table; and
transmitting the corresponding symbolic information to a display device for presentation of the symbolic information.

14. The method of claim 13, wherein the processor is connected to one of a bracelet and a watch.

15. The method of claim 13, further comprising: positioning a different one of the secondary inductance coils at different locations on each of a user's fingers and thumbs.

16. The method of claim 15, further comprising connecting the primary and secondary coils to at least one of: a glove, a plurality of finger bands, the user's torso, and the user's legs.

17. The method of claim 1, wherein the symbolic information includes a string of characters.
